(19) United States
(12) Patent Application Publication
(10) Pub. No.: US 2019/0329471 A1
(43) Pub. Date: Oct. 31, 2019

(54) DIE PIN HAVING CERAMIC TIP FOR MOLTEN PLASTIC EXTRUSION

(71) Applicant: GRAHAM PACKAGING COMPANY, L.P., Lancaster, PA (US)

(72) Inventors: Jason E. Burns, York, PA (US); Larry M. Taylor, Landisville, PA (US)

(73) Assignee: GRAHAM PACKAGING COMPANY, L.P., Lancaster, PA (US)

(21) Appl. No.: 15/964,878

(22) Filed: Apr. 27, 2018

(51) Int. Cl. B29C 47/20; B29C 47/00; B29B 11/10

(52) U.S. Cl. CPC B29C 47/20; B29L 2031/712; B29B 11/10; B29C 47/0023

(57) ABSTRACT

A die pin for forming a hollow plastic parison is provided, the die pin having a base member with a proximal mounting portion, a body portion, and a distal frustoconical portion, wherein the base member comprises a first material, and a tip member mounted on the distal frustoconical portion, wherein the tip member comprises a second material, the second material being different than the first material. An extrusion apparatus and method for forming a hollow plastic parison using the die pin are also provided.

### BACKGROUND OF THE DISCLOSED SUBJECT MATTER

### Field of the Disclosed Subject Matter

The disclosed subject matter is related to apparatus and methods for the extrusion of molten plastic material, and particularly to die pins for use in the same.

### Description of the Related Art

A variety of systems using molten thermoplastic extrusion are widely employed for the manufacture of plastic articles, including plastic containers and the like. Generally, plastic polymer pellets are melted within a heated extrusion apparatus under pressure and extruded through an outlet. In certain circumstances, the molten plastic or extrudate is extruded in the form of a tube or other hollow member, such as for blow molding techniques. For example, molten plastic is extruded from the extrusion apparatus in an annular space defined between an outlet and a tooling or die pin disposed within the outlet to shape the molten plastic into a hollow parison.

Die pins for extrusion of molten plastic for container blow molding are conventionally made of tool steel. However, steel die pins are susceptible to the accumulation of degraded molten plastic during repeated cycles of plastic extrusion. In rare instances, on the order of one in ten million, the accumulated degraded molten thermoplastic material may be ejected into a parison, resulting in a solid plastic contaminant. A representative contaminant associated with prior art die pins is shown in FIG. 1A, and a comparative infrared spectroscopy analysis of the contaminant and of a finished container is shown in FIG. 1B. The contaminant has an irregular appearance with a brown and black color, and spectroscopic and melting point analyses confirm the contaminant is composed of degraded thermoplastic material of the same polymer composition as the finished container.

To prevent container contamination associated with prior art die pins, it may be necessary to undertake laborious and expensive measures, including periodic phase resets to dislodge the contaminants and line shutdown to permit cleaning of the tooling. However, such efforts are time-consuming and costly, and further require line shutdown, resulting in reduced output. Line shutdown is also associated with increased energy consumption, as the molten plastic must be reheated upon restart.

There thus remains a continued need for an efficient and economic system for minimizing the undesirable accumulation of thermoplastic material in extrusion equipment. There further is a need for such systems with a die pin configured to contact an inner surface of a die ring to separate a hollow plastic parison being formed therebetween. The presently disclosed subject matter satisfies these and other needs.

### SUMMARY OF THE DISCLOSED SUBJECT MATTER

The purpose and advantages of the disclosed subject matter will be set forth in and are apparent from the description that follows, as well as will be learned by practice of the disclosed subject matter. Additional advantages of the disclosed subject matter will be realized and attained by the apparatus particularly pointed out in the written description and claims hereof, as well as from the appended drawings.

To achieve these and other advantages and in accordance with the purpose of the disclosed subject matter, as embodied and broadly described, the disclosed subject matter includes a die pin for forming a hollow plastic parison, the die pin comprising a base member having a proximal mounting portion, a body portion, and a distal frustoconical portion, wherein the base member comprises a first material; and a tip member mounted on the distal frustoconical portion, wherein the tip member comprises a second material, the second material being different than the first material.

For example, and as embodied herein, the distal frustoconical portion can include a mounting cavity. The tip member can include a rod extending into the mounting cavity of the distal frustoconical portion. The mounting cavity of the distal frustoconical portion can include interior threads configured to form a connection with exterior threads on the rod of the tip member. Thus, for illustration and not limitation, a threaded connection can be used between the distal frustoconical portion and the tip member. Additionally or alternatively, a bonding agent can be disposed between the tip member and the distal frustoconical portion.

As embodied herein, the base member can comprise metal and/or the tip member can comprise ceramic. The proximal mounting portion, body portion, and distal frustoconical portion of the base member can be integrally formed as a single piece. The proximal mounting portion of the base member can include threads configured to be coupled to a connection portion of an extrusion apparatus.

In accordance with another aspect of the disclosed subject matter, the disclosed subject matter includes an extrusion apparatus for forming a hollow plastic parison, the extrusion apparatus comprising a die ring having an inner surface defining an extrusion opening with a central axis. A die pin is disposed within the extrusion opening and aligned with the central axis. The die pin can comprise a base member having a proximal mounting portion, a body portion, and a distal frustoconical portion. The base member can comprise a first material. A tip member can be mounted on the distal frustoconical portion. The tip member can comprise a second material, the second material being different than the first material, and the tip member can comprise a base circumference that is less than a circumference of the extrusion opening. An annular space can be defined between an outer surface of the die pin and the inner surface of the die ring.

As embodied herein, the die pin can be moveable relative to the die ring to move axially toward and away from the extrusion opening.

As embodied herein, the outer surface of the base member can be configured to engage the inner surface of the die ring when the die pin is moved toward the extrusion opening. For example and not limitation, the outer surface of the distal frustoconical portion can be configured to engage the inner surface of the die ring when the die pin is moved toward the extrusion opening.

In accordance with another aspect of the disclosed subject matter, a method for forming a hollow plastic parison can comprise disposing a die pin within an extrusion opening defined by an inner surface of a die ring, the die pin being aligned with a central axis of the extrusion opening, wherein the die pin can comprise a base member having a proximal mounting portion, a body portion, and a distal frustoconical portion, and a tip member mounted on the distal frustoconical portion. The tip member can comprise a base circumference that is less than a circumference of the extrusion opening. The base member can comprise a first material and the tip member can comprise a second material, the second material being different than the first material. An annular space can be defined between an outer surface of the die pin and the inner surface of the die ring, and molten plastic can be directed through the annular space between the die ring and the die pin to form the hollow plastic parison without accumulation of the molten plastic on the die ring.

As embodied herein, the method can further include separating the hollow plastic parison by contacting an outer surface of the base member of the die pin with the inner surface of the die ring. For example, and not limitation, the method can include separating the hollow plastic parison by contacting an outer surface of the distal frustoconical portion of the die pin with the inner surface of the die ring.

It is to be understood that both the foregoing general description and the following detailed description and drawings are examples and are provided for purpose of illustration and not intended to limit the scope of the disclosed subject matter in any manner.

The accompanying drawings, which are incorporated in and constitute part of this specification, are included to illustrate and provide a further understanding of the apparatus of the disclosed subject matter. Together with the description, the drawings serve to explain the principles of the disclosed subject matter.

### BRIEF DESCRIPTION OF THE DRAWINGS

The subject matter of the application will be more readily understood from the following detailed description when read in conjunction with the accompanying drawings, in which:

FIG. 1A is an image of a degraded plastic contaminant associated with prior art die pins, and FIG. 1B is an infrared spectroscopy analysis of the degraded plastic contaminant shown in FIG. 1A and a reference infrared spectroscopy analysis of the plastic material of a corresponding container.

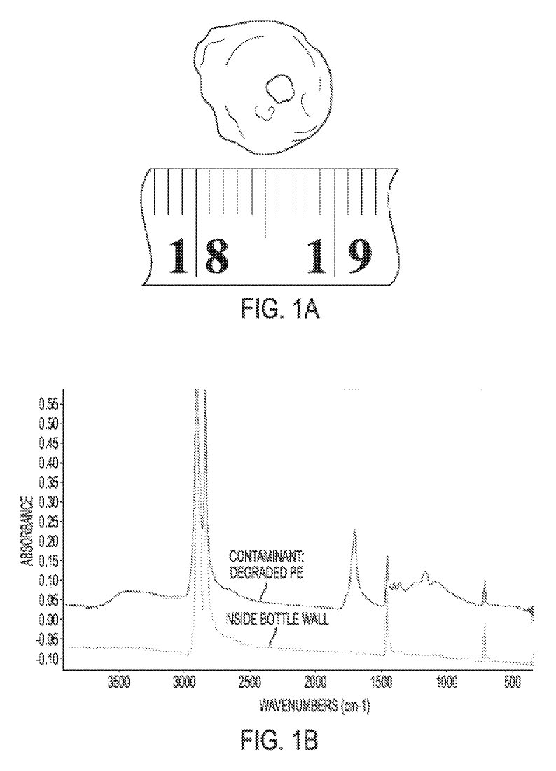

FIG. 2A is a cross-sectional side view of an exemplary die pin having a tip member according to the disclosed subject matter, the die pin being shown disposed within, and in contact with, a die ring.

FIG. 2B is a side view of an exemplary die pin disposed within an extrusion opening of a die ring and spaced from the die ring according to the disclosed subject matter, with the die ring shown in cross-section.

FIG. 2C is a side view of an exemplary die pin disposed within an extrusion opening of a die ring and in contact with the die ring according to the disclosed subject matter, with the die ring shown in cross-section.

### DETAILED DESCRIPTION

Reference will now be made in detail to embodiments of the disclosed subject matter, an example of which is illustrated in the accompanying drawings. The disclosed subject matter will be described in conjunction with the detailed description of the system. The method of the disclosed subject matter will be described in conjunction with the detailed description of the figures and examples provided herein.

As disclosed herein, the apparatuses and methods presented herein can be used for minimizing the undesirable accumulation of thermoplastic material in extrusion equipment. In particular, the disclosed apparatuses and methods can be used to form a hollow plastic parison from molten thermoplastic material. Thermoplastic material can accumulate on the surfaces of the extrusion equipment during manufacturing and, in certain instances, can degrade and contaminate the plastic extruded through the equipment, e.g., by falling into a hollow plastic parison. The apparatuses and methods disclosed herein can use a die pin having a ceramic tip member to reduce or prevent such accumulation.

For illustration, such apparatuses and methods can be used in an extrusion apparatus in which a parison is separated from the extruded plastic material surrounding a die pin by contacting the die pin against a surrounding die ring, e.g. by relative movement of the die pin axially toward and away from the die ring. As such, the parison, extending through and beyond the extrusion opening, can be separated from the upstream extruded plastic material within the extrusion system as a result of the die pin contacting the surface of the die ring. In an extrusion apparatus that severs plastic parisons from the die pin by such contact, the die pin must be strong enough to withstand the force of repeated contact between the die pin and the die ring. Accordingly, specific configurations of die pins disclosed herein can be employed in such extrusion apparatuses, among others, to minimize the undesirable accumulation of thermoplastic material on the die pin while protecting the die pin from increased wear, and preserving or improving the overall durability of the die pin.

Unless otherwise defined, all technical and scientific terms used herein have the same meanings as commonly understood by one of ordinary skill in the art to which the disclosed subject matter belongs. Although methods and materials similar or equivalent to those described herein can be used in its practice, suitable methods and materials are described below.

It is to be noted that the term “a” entity or “an” entity refers to one or more of that entity. As such, the terms “a”, “an”, “one or more”, and “at least one” can be used interchangeably herein. The terms “comprising,” “including,” and “having” can also be used interchangeably. In addition, the terms “amount” and “level” are also interchangeable and can be used to describe a concentration or a specific quantity. Furthermore, the term “selected from the group consisting of” refers to one or more members of the group in the list that follows, including mixtures (i.e., combinations) of two or more members.

The term “about” or “approximately” means within an acceptable error range for the particular value as determined by one of ordinary skill in the art, based upon the technique used to measure the value, i.e., the limitations of the measurement system. For example, “about” can mean within 3 or more than 3 standard deviations, per the practice in the art. Alternatively, “about” can mean a range, for example, of up to +/−20%, or up to +/−10%, or up to +/−5%, or up to +/−1% of a given value.

In accordance with the disclosed subject matter, a die pin is provided for forming a hollow plastic parison. The die pin disclosed herein includes a base member having a proximal mounting portion, a body portion, a distal frustoconical portion, and a tip member mounted on the distal frustoconical portion. The base member comprises a first material and the tip member comprises a second material, the second material being different than the first material.

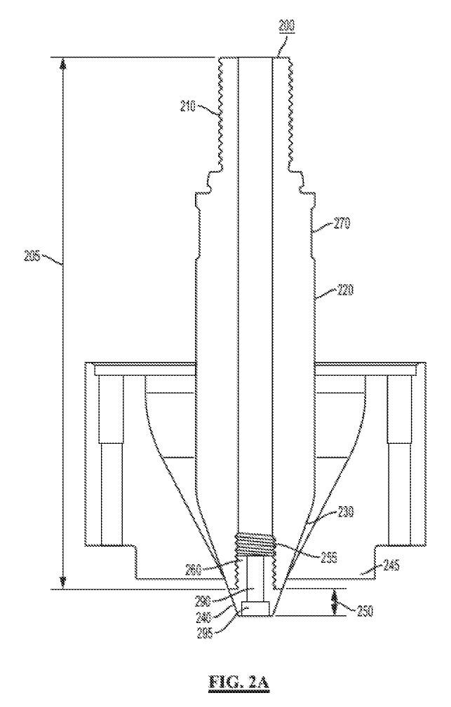

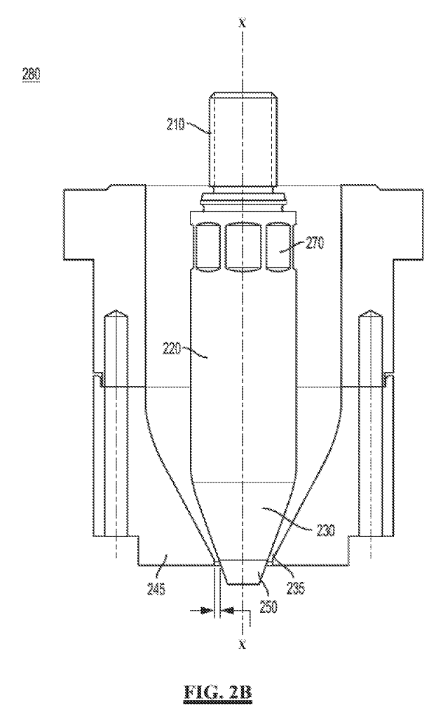

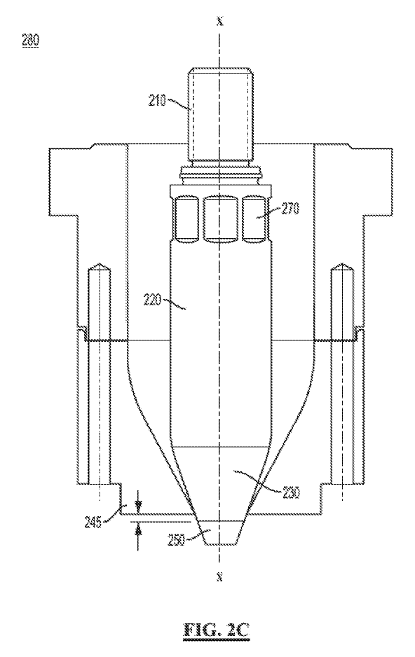

Solely for purpose of illustration, an exemplary embodiment of a die pin is shown schematically in FIGS. 2A-2C. The examples herein are not intended to limit the scope of the disclosed subject matter in any manner. Particularly, and as illustrated, the disclosed subject matter provides a die pin 200 for forming a hollow plastic parison.

As illustrated, and with reference to FIG. 2A, the die pin 200, shown disposed within a die ring, can comprise a base member 205 having a proximal mounting portion 210, a body portion 220, and a distal frustoconical portion 230. The die pin 200 can further comprise a tip member 240 mounted on the distal frustoconical portion 230 of the base member and extending distally from the distal frustoconical portion 230. All or a portion of the tip member 240 can have a frustoconical or conical shape that aligns with and continues the frustoconical shape of the distal frustoconical portion 230 such that a distal region of the die pin has an overall frustoconical or conical shape.

As embodied herein, the proximal mounting portion 210, body portion 220, and distal frustoconical portion 230 of the base member 205 can be integrally formed as a single piece. Alternatively, one or more of the proximal mounting portion 210, body portion 220, and distal frustoconical portion 230 can be separately formed and incorporated by any suitable means, including, without limitation, threading, welding, or the like. For example, the body portion 220 and distal frustoconical portion 230 can be integrally formed and the proximal mounting portion 210 can be separately formed and attached to the proximal end of the body portion 220.

For example, and not by way of limitation, the proximal mounting portion 210 can further include a feature to cooperate with and attach to a feature of the body portion 220 of the base member 205. For illustration only, the proximal mounting portion 210 can comprise a mounting cavity (not shown) to receive a rod (not shown) extended from the body portion 220 of the base member 205. This connection can be bonded or threadingly engaged to mount the body portion 220 onto the proximal mounting portion 210.

As illustrated in FIG. 2A, and not by way of limitation, the proximal mounting portion 210 can comprise threads or another attachment means configured to be coupled to a connection portion of an extrusion apparatus. In some embodiments, the base member 205 can include a polygonal region 270 to facilitate a conventional tool to rotatably engage the proximal mounting portion 210 with the connection portion. The polygonal region 270 can comprise flat or substantially flat portions or regions on the circumference of the base member 205. Such regions or portions can be of varying sizes and shapes, and varying placements along the base member 205. For example, and not limitation, a polygonal region 270 can be placed toward the proximal mounting portion. The polygonal region 270 can thereby be adapted to permit fixing or mounting of the die pin 200 onto the connection portion of an extrusion apparatus, such as by a wrench. Additionally or alternatively, the proximal mounting portion 210 can include other features to engage with the connection portion of an extrusion apparatus, e.g., clips, recesses, pins, or the like.

As noted above and with reference to FIG. 2A, the die pins disclosed herein can further include a tip member 240. The tip member 240 can include a head portion 250 having an overall frustoconical or conical shape. As embodied herein, the tip member 240 can be hollow, for example, comprising a bore 290 through the center of the tip member 240. The bore can be a constant diameter. Alternatively, the tip member 240 can comprise a bore 290 with a first diameter in the center of the tip member along a proximal portion of the tip member, and a bore of a second larger diameter 295 in the center of the tip member along a distal portion of the tip member that does not continue for the full length of the tip member as shown in FIG. 2A. Alternatively, the tip member 240 can be solid throughout.

As embodied herein, the tip member 240 and the base member 205 can be connected via any suitable means, as known in the art. For example, the distal frustoconical portion 230 of the base member 205 can comprise a mounting cavity 255 configured to receive the tip member 240. For example, as depicted in FIG. 2A, the mounting cavity 255 can extend longitudinally into the distal frustoconical portion 230 of the base member 205. As embodied herein, the mounting cavity 255 can extend through the entire length of the distal frustoconical portion 230, and can optionally extend beyond the distal frustoconical portion 230 and into other features of the base member 205, e.g., the body portion 220 and/or the proximal mounting portion 210. Alternatively, the length of the mounting cavity 255 can be less than that of the distal frustoconical portion 230 such that the mounting cavity extends only partially into the distal frustoconical portion.

Thus, and as illustrated in FIG. 2A, the tip member 240 can comprise a rod 260 that corresponds to the mounting cavity 255 of the base member 205. The rod 260 can extend from a head portion 250 of the tip member 240 and have a diameter that is less than the proximal diameter of the head portion. As shown in FIG. 2A, the rod 260 can extend into the mounting cavity of the base member 205 in order to anchor the tip member 240 onto the base member 205. For example, and not limitation, the rod 260 can be of varying lengths and can extend into the mounting cavity 255, through the base member 205, up to the full length of the mounting cavity. A person of skill in the art will appreciate that, although reference is made to a mounting cavity on the base member for cooperating with a rod on the tip member, the rod can be disposed on the base member with a corresponding mounting cavity on the tip member, and similar principles would apply thereto.

As embodied herein, a connection can be formed between the mounting cavity 255 and the rod 260 using any suitable means. For example, as illustrated in FIG. 2A and not by way of limitation, the mounting cavity of the distal frustoconical portion 230 can comprise interior threads configured to form a connection with exterior threads on the rod 260 of the tip member 240. A threaded connection can thereby be formed between the distal frustoconical portion 230 of the base member 205 and the tip member 240. In addition, or alternatively, a bonding agent can be disposed between the tip member 240 and the base member 205. For example, a bonding agent can be placed between the rod 260 and the mounting cavity 255. In this manner, the connection between the tip member 240 and the base member 205 can be achieved and/or strengthened. Suitable bonding agents include, by way of example and not limitation, epoxide and acrylate-based bonding agents.

As embodied herein, the die pins disclosed herein can be suitable for incorporation into an extrusion apparatus for forming a hollow plastic parison. Such an extrusion apparatus can comprise a die ring having an inner surface defining an extrusion opening with a central axis. For illustration and not limitation, and with reference to FIGS. 2B and 2C, a die pin 200 can be disposed within an extrusion opening 235 defined by an inner surface of a die ring 245 of an extrusion apparatus 280. The die pin 200 can be aligned with a central axis x-x of the extrusion opening 235.

As illustrated in FIG. 2B, the tip member 240 can comprise a maximum base diameter that is less than the inner diameter of the extrusion opening 235. The die pin 200 can be configured to move relative to the extrusion opening 235 along the central axis x-x. When the die pin 200 is moved relative to and away from the extrusion opening 235 to a retracted position, an annular space can be defined between an outer surface of the die pin 200 and an inner surface of the die ring 245. For example, the die pin can 200 can be connected to a die stem, which can be driven toward and away from the die ring, for example by a powered actuator or the like. By directing molten plastic through this annular space between the die pin 200 and the die ring 245, a hollow plastic parison can be formed, extending through and beyond the extrusion opening, without accumulation of the molten plastic on the die pin 200 or die ring 245. Separation of the hollow plastic parison from the upstream extruded plastic material within the extrusion system can be achieved via brushing, in which the die pin 200 is moved relative to and toward the extrusion opening 235 such that the outer surface of the die pin 200 comes in contact with the inner surface of the die ring 245 (as shown in FIG. 2C), so as to sever the parison that is extending beyond the extrusion opening and release it from the die pin 200 and die ring 245.

As noted above, the materials of the apparatuses disclosed herein can be selected to simultaneously prevent the accumulation of thermoplastic material on the surface of the die pin and extrusion apparatus, while having the strength and durability to withstand the contact forces encountered during brushing of the die pin against the extrusion apparatus. Due to these two-fold requirements, the base member 205 and the tip member 240 can comprise two different materials.

For example, the material of the base member 205 can be selected to withstand the forces encountered during manufacturing, whereas the material of the tip member 240 can be selected to reduce or prevent accumulation of thermoplastic material on the die pin. As such, the base member 205 can be formed from a material that is more durable than the material used to form the tip member 240 (for example, ceramic as detailed below). As such and as shown in FIGS. 2B and 2C, it is advantageous to form the tip member 240 with a maximum base diameter less than the inner diameter of the extrusion opening such that, during brushing, the inner surface of the die ring 245 contacts the outer surface of the distal frustoconical portion 230 of the die pin 205 and does not contact the tip member 240. In this manner, when brushing occurs as the die pin 200 is moved relative to the extrusion opening 235 of the die ring 245, the entire tip member 240 will pass through the extrusion opening 235 without contacting the inner surface of the die ring, and the inner surface of the die ring will only contact an outer surface of the base member 205, e.g., the distal frustoconical portion 230, of the die pin 200. Thus, the outer surface of the base member 205 can be configured to engage the inner surface of the die ring 245. Specifically, the tip member 240 and the distal frustoconical portion 230 can be configured such that, in operation, the outer surface of the distal frustoconical portion 230 is configured to engage the inner surface of the die ring 245.

Accordingly, the tip member 240 can be formed of a material that is selected for its material and surface properties suited to reducing buildup of thermoplastic material on the tip member 240 whereas the base member 205 can comprise a more durable material capable of withstanding repeated forces caused by brushing, the interaction between the die ring 245 and the inner surface of the die pin to sever the hollow plastic parison from the upstream portion of plastic being extruded between the die pin 200 and the die ring 245. Thus, as embodied herein, the base member 205 can comprise a first material and the tip member 240 can comprise a second material, with the second material being different than the first material. For example, and not limitation, the base member 205 can comprise a metal that is able to withstand the contacting or brushing forces encountered in the extrusion apparatus. For example, but not limitation, the base member 205 can comprise tool steel. In contrast, the tip member 240 can comprise a ceramic material.

As disclosed herein, it was determined that die pins comprising a tip member 240 formed of a ceramic material are not susceptible to the accumulation of molten thermoplastic material and therefore can minimize contamination of extruded plastic parisons. Without limitation to a particular theory, it appears that the higher specific heat capacity of ceramic prevents localized cooling of the tip member as it is subject to continuous flow of pressurized air during parison formation. The disclosed die pins are therefore less susceptible to condensation of the molten thermoplastic material on the die pin, and specifically, the tip member. Additionally, ceramic material is less susceptible to non-covalent (e.g., electrostatic, hydrogen-bonding, and Van der Waals) interactions with the molten thermoplastic material than conventional tool steel pins. The die pins with ceramic tip members disclosed herein can be used with existing molten thermoplastic extrusion apparatuses.

Thus, and in accordance with one aspect of the disclosed subject matter, at least the tip member 240 of a die pin for molten thermoplastic extrusion is composed of at least one ceramic material. As used herein, ceramics refer to inorganic, nonmetallic materials made by the action of heat at temperatures sufficient to cause sintering, solid-state reactions, bonding, or conversion partially or wholly to the glassy state, and include without limitation crystalline oxides, nitrides and carbide materials. Suitable ceramics for use with the disclosed subject matter include, without limitation, alumina-based ceramics, boron-based ceramics, zirconia-based ceramics, and silicon-based ceramics. Alumina-based ceramics suitable for use with the disclosed subject matter include, without limitation, alumina oxides having a composition of 90% or greater alumina oxide, including 96% alumina oxide, 99.5% alumina oxide, and 99.8% alumina oxide. Suitable boron-based ceramics include boron nitrides and boron carbides. Suitable silicon-based ceramics include silicon carbides and silicon nitrides. Suitable zirconia-based ceramics include zirconia oxides such as magnesia stabilized zirconia, yttria stabilized zirconia, and zirconia toughened alumina.

In accordance with the disclosed subject matter, the ceramic material can be provided with a relatively smooth surface finish. Depending on the extrusion application, surface finishes of less than about 25 μm (about 1000 μinch) average roughness (Rₐ) can be suitable for the tip member 240. For example, the ceramic material can have a surface finish of between about 0.1 μm Rₐ (i.e., approximately 4 RMS) to about 12.5 μm Rₐ (i.e., approximately 550 RMS). More particularly, the ceramic material can have a surface finish of between about 0.1 μm Rₐ and about 1.6 μm Rₐ (i.e., approximately 64 RMS). Furthermore, the ceramic material can have a surface finish of about 0.1 μm to 0.8 μm Rₐ (i.e., approximately 32 RMS).

As embodied herein, the die pin disclosed herein can be suitable for use in extrusion of molten thermoplastic polymers for plastic containers. The die pin can be suitable for extrusion of, without limitation, polyethylene, low density polyethylene, high density polyethylene, polyethylene terephthalate, polypropylene, polystyrene, and polyvinylchloride.

In accordance with another aspect of the disclosed subject matter, a method for forming a hollow plastic parison is disclosed. The method includes disposing a die pin within an extrusion opening defined by an inner surface of a die ring. The die pin can be aligned with a central axis of the extrusion opening. As described above, the die pin comprises a base member having a proximal mounting portion, a body portion, and a distal frustoconical portion, and a tip member mounted on the distal frustoconical portion. The base member comprises a first material and the tip member comprises a second material that is different than the first material.

As discussed above, the method can further include separating the hollow plastic parison by contacting an outer surface of the base member of the die pin with the inner surface of the die ring. Specifically, the method can include separating the hollow plastic parison by contacting an outer surface of the distal frustoconical portion of the base member with the inner surface of the die ring when the die pin is moved toward the inner surface of the die ring. Such an action can be achieved by forming the tip member with a base circumference that is less than the circumference of the inner surface of the die ring (i.e., the extrusion opening), through which the die pin is disposed.

While the disclosed subject matter is described herein in terms of certain preferred embodiments, those skilled in the art will recognize that various modifications and improvements can be made to the disclosed subject matter without departing from the scope thereof. Additional features known in the art likewise can be incorporated, such as disclosed in U.S. Patent Publication No. 2015/0061179 A1, which is incorporated in its entirety by reference herein. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the various embodiments depicted and claimed, the disclosed subject matter is also directed to other embodiments having any other possible combination of the features disclosed and claimed herein. As such, the particular features presented herein can be combined with each other in other manners within the scope of the disclosed subject matter such that the disclosed subject matter includes any suitable combination of the features disclosed herein. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method, system, and apparatus of the disclosed subject matter without departing from the spirit or scope of the disclosed subject matter. Thus, it is intended that the disclosed subject matter include modifications and variations that are within the scope of the appended claims and their equivalents.

1. A die pin for forming a hollow plastic parison, the die pin comprising:
a base member having a proximal mounting portion, a body portion, and a distal frustoconical portion, wherein the base member comprises a first material; and
a tip member mounted on the distal frustoconical portion, wherein the tip member comprises a second material, the second material being different than the first material.

2. The die pin of claim 1, wherein the distal frustoconical portion comprises a mounting cavity.

3. The die pin of claim 2, wherein the tip member comprises a rod extending into the mounting cavity of the distal frustoconical portion.

4. The die pin of claim 3, wherein the mounting cavity of the distal frustoconical portion comprises interior threads configured to form a connection with exterior threads on the rod of the tip member.

5. The die pin of claim 1, further comprising a threaded connection between the distal frustoconical portion and the tip member.

6. The die pin of claim 1, further comprising a bonding agent between the tip member and the distal frustoconical portion.

7. The die pin of claim 1, wherein the base member comprises metal.

8. The die pin of claim 1, wherein the tip member comprises ceramic.

9. The die pin of claim 1, wherein the proximal mounting portion, body portion, and distal frustoconical portion of the base member are integrally formed as a single piece.

10. The die pin of claim 1, wherein the proximal mounting portion comprises threads configured to be coupled to a connection portion of an extrusion apparatus.

11. An extrusion apparatus for forming a hollow plastic parison, the extrusion apparatus comprising:
a die ring having an inner surface defining an extrusion opening with a central axis;
a die pin disposed within the extrusion opening and aligned with the central axis, the die pin comprising:
a base member having a proximal mounting portion, a body portion, and a distal frustoconical portion, wherein the base member comprises a first material; and
a tip member mounted on the distal frustoconical portion, wherein the tip member comprises a second material, the second material being different than the first material, and wherein the tip member comprises a base circumference that is less than a circumference of the extrusion opening,
wherein an annular space is defined between an outer surface of the die pin and the inner surface of the die ring.

12. The extrusion apparatus of claim 11, wherein the die pin is moveable relative to the die ring to move axially toward and away from the extrusion opening.

13. The extrusion apparatus of claim 12, wherein the outer surface of the base member is configured to engage the inner surface of the die ring when the die pin is moved toward the extrusion opening.

14. The extrusion apparatus of claim 12, wherein the outer surface of the distal frustoconical portion is configured to engage the inner surface of the die ring when the die pin is moved toward the extrusion opening.

15. A method for forming a hollow plastic parison, the method comprising:
disposing a die pin within an extrusion opening defined by an inner surface of a die ring, the die pin being aligned with a central axis of the extrusion opening, the die pin comprising:
a base member having a proximal mounting portion, a body portion, and a distal frustoconical portion, wherein the base member comprises a first material; and
a tip member mounted on the distal frustoconical portion, wherein the tip member comprises a second material, the second material being different than the first material, and wherein the tip member comprises a base circumference that is less than a circumference of the extrusion opening,
wherein an annular space is defined between an outer surface of the die pin and the inner surface of the die ring; and
directing molten plastic through the annular space between the die ring and the die pin to form the hollow plastic parison without accumulation of the molten plastic on the die ring.

16. The method of claim 15, further comprising separating the hollow plastic parison by contacting an outer surface of the base member of the die pin with the inner surface of the die ring.

17. The method of claim 15, further comprising separating the hollow plastic parison by contacting an outer surface of the distal frustoconical portion of the die pin with the inner surface of the die ring.
